(19) United States
(12) Patent Application Publication
(10) Pub. No.: US 2009/0029038 A1
(43) Pub. Date: Jan. 29, 2009

(54) Method of Forming Wiring Patterns Using Nano-Ink Comprising Metals Having Low Melting Point

(75) Inventors: Kook Nam Han, Seoul (KR); Nam Soo Kim, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: Industry-University Cooperation Foundation of Seokyeong University, Seoul (KR)

(21) Appl. No.: 12/140,744

(22) Filed: Jun. 17, 2008

(30) Foreign Application Priority Data
Jul. 25, 2007 (KR) 10-2007-0074379

(51) Int. Cl. B05D 5/12

(52) U.S. Cl. 427/98.4

(57) ABSTRACT

Disclosed is a method of forming a wiring pattern using nano-ink, including providing a mixture solution of at least one first metal selected from the group consisting of gold, silver, and copper and at least one second metal selected from the group consisting of lead, zinc, tin, indium, cadmium, gallium, and alloys thereof, having an average particle size ranging from 5 nm to 1 μm in a reducing atmosphere; forming a wiring pattern on a base layer using the mixture solution; and thermally treating the wiring pattern at 150˜300° C. in a reducing atmosphere. Even when metal having low electrical conductivity is used, a wiring pattern having high electrical conductivity can be formed. The use of the second metal having a low melting point enables thermal treatment at low temperatures, thus preventing damage to a base layer on which a wiring pattern is formed and preventing a reaction between the metal and the base layer.

This invention is a result of Seoul R&BD Program with respect to “Development of Process and Apparatus for 3D Microsystems Packaging” as Korean National Research and Development Works.

### BACKGROUND OF THE INVENTION

1. Field of the Invention

The present invention relates generally to a method of forming a wiring pattern using nano-ink, and, more particularly, to a method of forming a wiring pattern using nano-ink including metal having a low melting point.

2. Description of the Related Art

Nano-ink using minute and nano-sized metal particles has been studied in various fields, thanks to its high electrical conductivity, simple processing, and thermal treatability at low temperatures. Many commercialization studies thereof to date have been focused on the use thereof as ink of metal particles having high electrical conductivity, which are dispersed in water or an organic medium after having been prepared. Metal ink composed of minute particles makes it easy to write a lot of information in a small area, and thereby a wiring pattern is expected to be more effectively formed in a desired shape within a very short time, compared to when using a typical electronic circuit formation process, which is complicated, including 24 steps of screen printing, etching, and so on. If a functional element that enables the writing of the same quantity of information on a much smaller circuit is developed in order to substitute for the conventional process, the economic effects thereof are expected to be very large, and therefore, a process of using nano-ink, which is eco-friendly and generates economic benefits, across the entire industry, is expected to substitute for the conventional process.

The manufacture of electrically conductive ink is closely related to direct write technology (DWT). Thus, DWT, which is a hot research topic for many researchers all over the world these days, is considered to be an innovative process being able to substitute for presently available methods of forming electronic circuits. Therefore, it has been intensively investigated in various fields including the inkjet process, the spraying process, the laser process, the aerosol process, the direct contact patterning process, etc.

Metal particles, which constitute nano-ink as a core element of such DWT, are nano-sized, and are thus advantageous because a lot of information can be stored in a small area in the formation of a circuit using the same. However, in the completion of the process, many problems have yet to be technically overcome. The major requirement for electrically conductive ink useful for DWT is satisfactory electrical conductivity of a written pattern. This conductivity value is evaluated to be appropriate as long as it is 50˜70% of the electrical conductivity of copper, but the electrical conductivity of presently manufactured ink does not reach the above standard.

Moreover, a big problem in the manufacture of an ink exhibiting satisfactory electrical conductivity is that the adequate concentration of metals, which are a main component of electrically conductive ink. For example, copper, silver, and gold are difficult to control to a concentration level required to function as an ink. If ink is manufactured to meet the required concentration using the above metals, it does not exhibit desired electrical conductivity, attributing to the contact resistance and oxidation of metal particles after drying.

### SUMMARY OF THE INVENTION

Accordingly, the present invention provides a method of forming a wiring pattern having high electrical conductivity using nano-ink suitable for application to DWT.

In addition, the present invention provides a method of forming a wiring pattern having low contact resistance using nano-ink suitable for application to DWT.

In addition, the present invention provides a method of forming a wiring pattern having high electrical conductivity while preventing damage to a base layer using nano-ink suitable for application to DWT.

According to the present invention, a method of forming a wiring pattern using nano-ink may comprise of a mixture solution of at least one first metal selected from the group consisting of gold, silver, and copper and at least one second metal selected from the group consisting of lead, zinc, tin, indium, cadmium, gallium, and alloys thereof, having an average particle size ranging from 5 nm to 1 μm in a reducing atmosphere; forming a wiring pattern on a base layer using the mixture solution; and thermally treating the wiring pattern at 150˜300° C. in a reducing atmosphere.

In the present invention, the weight ratio of the first metal to the second metal is preferably in the range of 3:1˜1:3.

Further, the reducing atmosphere of the mixture solution is preferably realized using at least one reducing agent selected from the group consisting of carbon, sodium borohydride, hydrogen gas, hydrazine sulfide, hydrogen iodide, phosphine, arsine, stibine, sulfur dioxide, sulfite ions, phosphorous acid, potassium formate, cuprous ions, and stannous ions.

In the present invention, the weight ratio of solvent to metal particles in the solution is preferably 3:1˜1:3.

### BRIEF DESCRIPTION OF THE DRAWING

FIG. 1 is a graph showing the electrical conductivity of a wiring pattern formed according to the present invention.

### DESCRIPTION OF THE PREFERRED EMBODIMENTS

Hereinafter, a detailed description will be given of a method of forming a wiring pattern according to the present invention.

First, a nano-metal mixture solution is prepared. In the present invention, the metal mixture solution is a solution in which two or more nano-metals having a difference in conductivity are dispersed. More specifically, the metal mixture solution includes a first metal and a second metal. The first metal includes metal having high electrical conductivity, for example, at least one selected from the group consisting of silver, copper, gold, and platinum. The second metal may be at least one selected from the group consisting of lead, zinc, tin, indium, cadmium, gallium, and alloys thereof. In the present invention, it is preferred that the metals of the metal mixture solution be in a nano-sized metal powder form. Such nano-metal powder indicates metal having an average particle size of 1 μm or less, and preferably an average particle size ranging from 5 nm to 1 μm. The nano-metal powder having the above size may be prepared through a wet process. As an example thereof, a process of preparing nano-silver powder is described below.

Pure silver is dissolved in acetic acid or nitric acid, and is then diluted with distilled water, thus preparing a silver acetate solution or a silver nitrate solution having a silver concentration of 100,000 ppm. Further, a solution containing a reducing agent, for example, but not limited to, a sodium borohydride (NaBH₄) solution and/or a hydrazine (N₂H₄) solution, is prepared. This solution may be prepared by adding either or both of 1˜50 ml of hydrazine and 0.5˜50 g of sodium borohydride to 1 l of distilled water. Furthermore, a solution containing a dispersant selected from among amines, sulfonates, silicates, acrylic polymers, starch, and mixtures thereof is prepared. The solutions thus prepared are placed in a reactor, and are then allowed to react, thus preparing metal powder. The reaction precipitate is dried through evaporation, freezing, or room temperature or high temperature sonication. In the drying process, an additional reducing system may be used, as necessary. For instance, metal powder may be prepared through thermal treatment at about 25˜1000° C. using nitrogen or argon as a carrier gas in the presence of a reducing gas such as hydrogen or carbon monoxide.

The first and second metal powders, which are nanoparticles, prepared through the above process, are mixed in water or an organic solvent. In the present invention, examples of the organic solvent include alcohol and derivatives thereof, such as ether and phenol. In particular, it is preferred that the mixture solution be maintained in a reducing atmosphere. As such, the reducing atmosphere may be maintained through various processes, including the addition of a reducing agent, the supply of an inert gas to the solution to remove oxygen, or the addition of an oxygen scavenger to the solution. The reducing agent may be at least one selected from the group consisting of sodium borohydride, hydrogen gas, hydrazine sulfide, hydrogen iodide, phosphine, arsine, stibine, sulfur dioxide, sulfite ions, phosphorous acid, potassium formate, cuprous ions, and stannous ions. In the mixture solution of the present invention, the weight ratio of nano-metal powder to solvent preferably falls in the range of 1:3˜3:1.

Subsequently, a wiring pattern is printed on a predetermined base layer using the nano-metal mixture solution. The printing of the wiring pattern may be conducted through a direct printing process, for example, the inkjet process, the spraying process, the laser process, an the aerosol process, or the direct contact patterning process.

Subsequently, the printed wiring pattern is thermally treated. Thermal treatment is conducted to evaporate water or the solvent so as to increase the probability of contact between the metal particles. In the present invention, the second metal has a melting point lower than that of the first metal. Table 1 below shows the electrical conductivity and melting points of general metals, including metals used in the present invention.

TABLE 1

| | | Melting | Conductivity × 10⁶ |
|---|---|---|---|
| Metal/Ion | EMF (volts SHE) | Point (° C.) | (ohm⁻¹cm¹) |
| Au/Au⁺⁺⁺ | 1.5 | 1064.6 | 0.452 |
| Pt/Pt⁺⁺ | 1.19 | 1771.8 | 0.096 |
| Ag/Ag⁺ | 0.799 | 960.8 | 0.630 |
| Cu/Cu⁺⁺ | 0.337 | 1084.4 | 0.596 |
| Sb/SbO⁺ | 0.212 | 630.8 | 0.028 |
| H₂/H⁺ | 0.0 | −259.2 | 0.108 |
| Pb/Pb⁺⁺ | −0.126 | 327.4 | 0.048 |
| Sn/Sn⁺⁺ | −0.136 | 231.8 | 0.091 |
| Ni/Ni⁺⁺ | −0.250 | 1452.8 | 0.143 |
| In/In⁺⁺ | −0.269 | 156.6 | 0.116 |
| Co/Co⁺⁺ | −0.277 | 994.8 | 0.172 |
| Cd/Cd⁺⁺ | −0.403 | 321 | 0.138 |
| Fe/Fe⁺⁺⁺ | −0.440 | 1535.7 | 0.093 |
| Ga/Ga⁺⁺⁺ | −0.529 | 29.7 | 0.067 |
| Al/Al⁺⁺⁺ | −1.663 | 660.1 | 0.377 |

As is apparent from Table 1, the second metal of the present invention, lead, zinc, tin, indium, cadmium, and gallium has a melting point of 330° C. or less. Also, it goes without saying that the second metal includes the other metals having a melting point lower than that of the first metal, in addition to the above metals. The second metal may be alloyed with another metal having a low melting point, or may be formed into a eutectic alloy with the first metal, and thereby may be melted at a eutectic temperature lower than the melting point thereof. In the present invention, the thermal treatment is conducted at 150˜300° C., and preferably 200° C. or less. Such low-temperature thermal treatment is responsible for preventing damage to the base layer and inhibiting the chemical reaction between the base layer and the particles.

Further, the second metal melts at a low thermal treatment temperature or is subjected to eutectic treatment with the first metal, and thereby functions to electrically bind the first metal. Accordingly, the first metal is electrically cross-linked, and the contact resistance thereof is decreased. As is apparent from the following exemplary embodiments, the weight ratio of second metal/first metal to be mixed together should be preferably 1 or more. As shown in Table 1, whereas the first metal has a high melting point and high electrical conductivity, the second has a low melting point and low electrical conductivity. In this way, in the case where a metal composite composed of metals having a difference in electrical conductivity is used to form an electrical wiring pattern, the resultant electrical conductivity may be predicted based on a physical model.

Tables 2 and 3 below show exemplary cases in which the to electrical conductivity may be forecasted depending on the amount (vol %) of the first metal on the assumption that two metals having different electrical conductivity values are arranged in series and parallel, respectively. As such, as the first metal, copper particles (0.596×10⁶ scm⁻¹) were used, and as the second metal, M1, M2, and M3 having different electrical conductivity values (M1=0.116×10⁶ scm⁻¹, M2=0.06×10⁶ scm⁻¹, and M3=0.006×10⁶ scm⁻¹) were used. Further, the experiment was conducted on the assumptions that there was no contact resistance between the particles and that the two metals had similar densities.

TABLE 2

| | % Electrical Conductivity | | |
|---|---|---|---|
| | of Copper (Series) | | |
| Cu, vol % | Cu + M1 | Cu + M2 | Cu + M3 |
| 10 | 21 | 11 | 1 |
| 20 | 23 | 12 | 1 |
| 30 | 26 | 14 | 1 |
| 40 | 29 | 16 | 2 |
| 50 | 33 | 18 | 2 |
| 60 | 38 | 22 | 2 |
| 100 | 100 | 100 | 100 |

TABLE 3

| | % Electrical Conductivity | | |
|---|---|---|---|
| | of Copper (Parallel) | | |
| Cu, vol % | Cu + M1 | Cu + M2 | Cu + M3 |
| 10 | 28 | 19 | 11 |
| 20 | 36 | 28 | 21 |
| 30 | 44 | 37 | 31 |
| 40 | 52 | 46 | 41 |
| 50 | 60 | 55 | 51 |
| 60 | 68 | 64 | 60 |
| 100 | 100 | 100 | 100 |

As is apparent from Tables 2 and 3, the amount of the second metal (M1, M2, M3) can be seen to greatly influence the total electrical conductivity of metal composite. In addition, the electrical conductivity can be seen to be more greatly influenced by the arrangement of the metal particles than by the amount of metal. As shown in FIG. 2, in the case where the particles are randomly mixed and arranged in series, when copper is mixed with M3, the total electrical conductivity is estimated to be very low, to a level that does not exceed 2% of the electrical conductivity of bulk copper despite the use of 60% copper. On the other hand, as shown in Table 3, in the case where the metal particles are distributed in an interlayer arrangement (parallel type), when the electrical conductivity of the second metal is 0.116×10⁶ scm⁻¹, the total electrical conductivity is 50% or more of the electrical conductivity of copper even in the use of 40% copper. Theoretically, further, if the metal particles are combined in a parallel structure under conditions in which the electrical conductivity of the second metal is very low, to a level of 0.006×10⁶ scm⁻¹ (M3), the total electrical conductivity is 41% of the electrical conductivity of copper even in the use of 40% copper. Like this, studies on the arrangement of the metal particles are considered to be very important in terms of the application thereof to the field of electrically conductive ink.

In the exemplary embodiment of the present invention, silver particles (conductivity: 6.3×10⁵ scm⁻¹), as the first metal, and indium particles (conductivity: 1.16×10⁵ scm⁻¹), as the second metal, were mixed in different amounts, after which the mixture was printed on the base layer and then dried. Subsequently, the electrical conductivity of the wiring pattern was measured. As such, in order to maintain the mixture solution in a reducing atmosphere, carbon was added as a reducing agent, and the thermal treatment temperature was maintained at 200° C.

It should be noted that metal, other than gold and silver, is easily oxidized. As such, the oxidation of such a metal mainly occurs on the surface thereof. If so, such a metal has an oxidized film on its surface when melted, and thus cannot function as a cross-linker. Therefore, in this experiment, the two metals are mixed, after which an oxidizing atmosphere should be eliminated from the solution. To this end, oxygen is removed from the solution through the aforementioned process, and further, upon thermal treatment, a reducing atmosphere must be continuously maintained. Thus, thermal treatment is preferably conducted in a CO/CO₂ or H₂/H₂O atmosphere or in a vacuum.

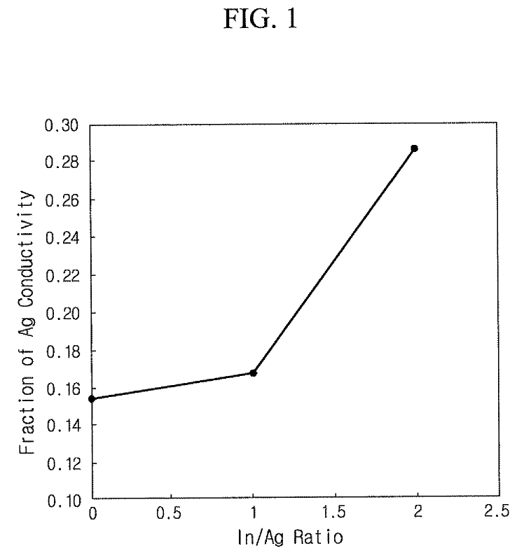

FIG. 1 is a graph showing the results of measurement of electrical conductivity depending on the weight ratio of indium/silver. As shown in FIG. 1, although the electrical conductivity of the wiring pattern should be the highest in the presence of only the silver particles, the conductivity can be seen to relatively increase when indium is added thereto at a ratio of 1:1 or 2:1. That is, whereas the electrical conductivity thereof is about 16% of the conductivity of silver in the presence of only the silver particles, the total conductivity can be shown to increase to 30% of the conductivity of silver by adding indium thereto and then performing thermal treatment so that indium is melted to thus decrease contact resistance. Even when another metal or alloy having a low melting point, other than indium, is added, the results can be confirmed to be the same.

As described above, the present invention provides a method of forming a wiring pattern using nano-ink including metal having a low melting point. According to the present invention, a first metal having high electrical conductivity and a high melting point is mixed with a second metal having low electrical conductivity and a low melting point, thus manufacturing ink, which is then used to form a wiring pattern. In this case, the wiring pattern can exhibit higher electrical conductivity than when using only the first metal. This is because the second metal functions to cross-link the first metal upon thermal treatment thanks to the low melting point thereof, resulting in decreased contact resistance. In this way, even when the metal having low electrical conductivity is used, a wiring pattern having high electrical conductivity can be formed. Further, the use of the second metal having a low melting point enables thermal treatment at low temperatures, thus preventing damage to the base layer on which the wiring pattern is formed and preventing a reaction between the metal and the base layer.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of forming a wiring pattern using nano-ink, comprising:
providing a mixture solution of at least one first metal selected from a group consisting of gold, silver, and copper and at least one second metal selected from a group consisting of lead, zinc, tin, indium, cadmium, gallium, and alloys thereof, having an average particle size ranging from 5 nm to 1 μm in a reducing atmosphere;
forming a wiring pattern on a base layer using the mixture solution; and
thermally treating the wiring pattern at 150˜300° C. in a reducing atmosphere.

2. The method as set forth in claim 1, wherein a weight ratio of the first metal to the second metal is in a range of 3:1˜1:3.

3. The method as set forth in claim 1, wherein the reducing atmosphere of the mixture solution is realized using at least one reducing agent selected from a group consisting of carbon, sodium borohydride, hydrogen gas, hydrazine sulfide, hydrogen iodide, phosphine, arsine, stibine, sulfur dioxide, sulfite ions, phosphorous acid, potassium formate, cuprous ions, and stannous ions.

4. The method as set forth in claim 1, wherein a weight ratio of solvent to metal particles in the solution is 3:1˜1:3.
